(19) United States
(12) Patent Application Publication
(10) Pub. No.: US 2005/0138117 A1
(43) Pub. Date: Jun. 23, 2005

(54) Method and system for pushing notifications to networked device

(75) Inventors: John William Chaney, Gilroy, CA (US); Alan Messer, Los Gatos, CA (US)

Correspondence Address: Kenneth L. Sherman, Esq.;Myers Dawes Andras & Sherman, LLP, Ste. 1150, 19900 MacArthur Blvd., Irvine, CA, 92612, US

(73) Assignee: Samsung Electronics Co., Ltd., Suwon City (KR)

(21) Appl. No.: 11/005,713

(22) Filed: Dec. 7, 2004

Related U.S. Application Data
(60) Provisional application No. 60/530,771, filed on Dec. 18, 2003.

(51) Int. Cl. G06F 15/16

(52) U.S. Cl. 709/203; 709/219; 709/206

(57) ABSTRACT

A method and system for pushing notifications to devices in a network including client devices and server devices. A connection is established between a client device and a server device. The client device sends a request for data to the server device. The server device sends a reply to the client device in response to the request, such that the reply contains a notification request for the client device to request further information from the server device. Further, the server device automatically notifies the client device that an event has occurred.

### CROSS-REFERENCE TO RELATED APPLICATIONS

Priority is claimed from U.S. Provisional Application No. 60/530,771, filed on Dec. 18, 2003, which is incorporated herein by reference.

### NOTICE OF INCLUSION OF COPYRIGHTED MATERIAL

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to pushing notifications to networked devices, and in particular to pushing notifications to home network devices using world wide web technologies.

### BACKGROUND OF THE INVENTION

Many electronic devices, for example home network devices, include support for Web browsers supporting the HTTP and HTML standards to display and render content from one device to another. Notifications may be sent form service devices to client devices for a number of reasons, including: alert messages, device status updates for general communication, etc.

Conventionally, when using a web browser in a client device as a controller for a service device, the web browser sends a request to a web server in the service device for status update. The web server then responds to the request with a status update (notification) which is then displayed in a display frame in the browser for user viewing. However, for the display frame to show up-to-date status information from the web server, the browser must periodically request the web server for an update. In response to each such request, the web server sends display information back to the browser even if no status change has occurred in a state machine monitored by the web server.

For dynamic status updates, the web browser periodically requests the web server for a status update at a particular polling rate. Any status change is reflected in the web browser display frame only when a request for update is sent to the web server and a response received from the server. This is because the conventional method is a polling method whereby the browser does not automatically receive status update information from the web server when the web server detects a status change.

There is, therefore, a need for a method and system that provides virtually real-time status updates in a client-based browser controller with low overhead.

### BRIEF SUMMARY OF THE INVENTION

The present invention addresses the above needs. A method and system for pushing notifications to devices in a network including client devices and server devices. A connection is established between a client device and a server device. The client device sends a request for data to the server device. The server device sends a reply to the client device in response to the request, such that the reply contains a notification request for the client device to request further information from the server device. Further, the server device automatically notifies the client device that an event has occurred.

In another embodiment, the present invention provides a system for pushing notifications to electronic devices, comprising: a client device and a server device, such that a connection can be established between the client device and a server device; the client device and the server device are configured such that: the client device sends a request for data to the server device; upon receiving the request, the server device sends a reply to the client device, wherein the reply includes a notification request for the client device to request further information from the server device.

Based on the notification request, the client device sends another request for data from the server device; and the server device sends another reply to the device in response to that request, wherein the reply includes another notification request for the client device to request further information from the server device. Further, the server device automatically notifies the client device that an event has occurred. The client device includes a web browser that sends the request and the server device includes a web server that sends the reply. The client device and the server device utilize the HTTP protocol. As such, in one version the present invention provides a push method and system for web browser command and control that provides virtually real-time status update to a browser-based controller from a service device web browser.

Other embodiments, features and advantages of the present invention will be apparent from the following specification taken in conjunction with the following drawings.

### BRIEF DESCRIPTION OF THE DRAWINGS

FIG. 1 shows an example functional block diagram of a network implementing a Push method notification scheme according to an embodiment of the present invention;

FIG. 2 shows an example system for pushing notifications to a client device web browser from a service device web server according to an embodiment of the present invention; and

FIG. 3 shows an example flowchart of the steps of pushing notifications between a client device and a server device in FIG. 2.

### DETAILED DESCRIPTION OF THE INVENTION

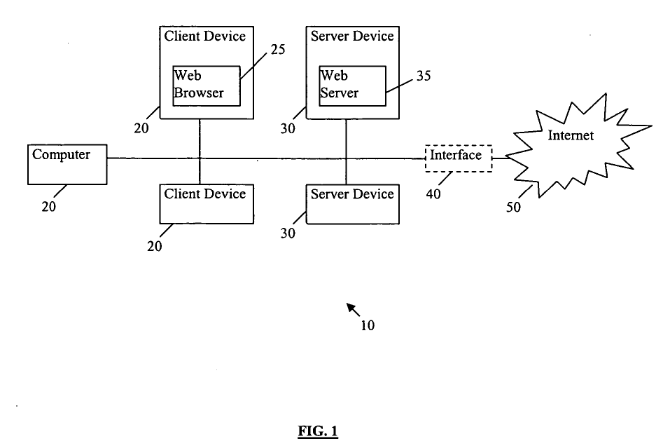

FIG. 1 shows an example functional architecture of a network 10, such as a home network, that implements a Push method notification scheme according to an embodiment of the present invention. The network 10 comprises client devices 20, server (service) devices 30, and optional interface 40 that connects the network 10 to the Internet 50. Though the client and server devices are shown as separate, a single physical device can include one or more client devices and one or more server devices. The client and server devices 20 and 30, respectively, implement the HTTP protocol for communication and protocol therebetween. Though in the example described herein the HTTP protocol is utilized by the network 10, those skilled in the art will recognize that the present invention is useful with other network communication protocols that utilize the client-server model. The present invention is useful with other communication protocols, including those protocols that have only one-way asynchronous messaging with response where the response is timed-out using a relatively large time value (he example client server protocols used in the embodiments described herein have that property). The last property can be seen as the client can ask the server for something at anytime, but the server only responds to queries from the client.

For example, a client device 20 can include a Web browser 25 and a server device 30 can include a Web server 35. The client and server devices 20 and 30, respectively, communicate via the TCP/IP network protocol (HTTP over any protocol may be used, the HTTP RFC's do not mandate underlying protocols; typically, the underlying protocol is either TCP/IP or UDP/IP, but HTTP itself is not restricted to that). An example client device 20 can be a TV, DVD, computer, etc. Further, an example server device 30 can be a TV, DVD, computer, etc.

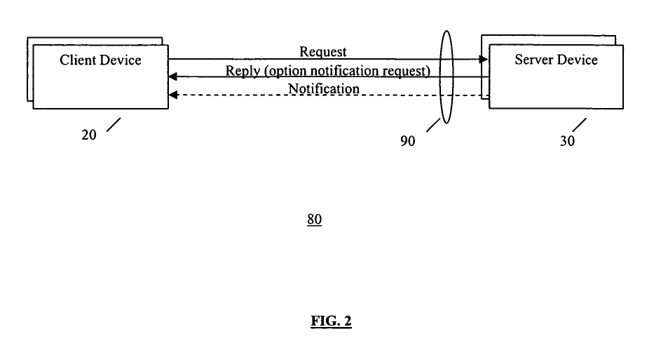

The network 10 implements a Push method and system for pushing updates for status and control mechanisms from the web sever 35 to the web browser 25. The Push method allows a service device to send status and notification messages directly to client device, independent of the version of HTTP supported, and for all MIME types. FIG. 2 shows an example system 80 that implements push notification between the client device 20 including the web browser 25 and the server device 30 including the web server 35, via a connection 90 in the network 10.

When the web browser 25 first requests information from the web server 35, the web server 35 delivers the requested information to the web browser 25. In that process, if the web server 35 wishes to send a notification to web browser 25, the web server 35 also delivers to the web browser 25 an update request (step 102). That update request can set in motion a task that is timed at the web browser 25 for requesting additional information from the web server 35. This process can be repeated. As such, from an initial browser request for information from the web server 35, the web server 35 delivers an update request that sets in motions a set of chained update requests over time.

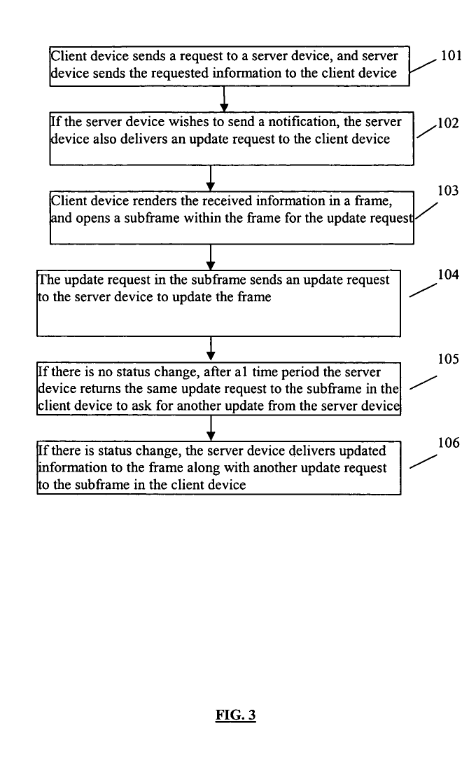

Further, FIG. 3 shows an example flowchart of the steps of update/notification method between the client device 20 and the server device 30 in FIG. 2. The web browser 25 initially requests information from the web server 35 to be displayed in a status frame on web browser 25, and the web server 35 delivers the requested information to the web browser 25 (step 101). In that process, if the web server 35 wishes to send a notification to web browser 25, the web server 35 also sends an update request to the web browser 25 to again request update for the status frame from the web server 35 (step 102). The update request asks the web server 35 to update the status frame repeatedly. In one example Push method for HTTP, the web browser 25 renders the received information in a status frame, and a subframe is utilized within the status frame, wherein the subframe comprises a one pixel iframe without borders (not visible) that is embedded within the status frame that is initially posted by the web server 35 in the web browser 25 (step 103). This subframe includes an update request (e.g., Javascript) to the web server 35 to update the status frame (step 104), which the web server 35 intentionally leaves unfulfilled for a fixed time period (e.g., 110 sec.). The web browser 26 is set to timeout HTTP requests after a certain timeout period (e.g., 120 sec.).

If the web server 35 does not have any notification or change of state status message to display to the user during the fixed time period, then at the end of the fixed time period (before expiration of the timeout period) the web server 35 returns the same update request to the subframe (step 105). If during the fixed time period a status change occurs, then the web server 35 sends an updated status to the status frame (i.e., parent frame of the subframe) and at the same time reloads the subframe with a new update request (step 106). Preferably, the web server 35 sends updated status to the status frame as soon as the web server 35 detects such change. This example utilizes the parent frame's properties and location method of Javascript 1.2. The web sever 35 stops sending the web browser 25 such update requests upon e.g. completion of a task that the web server is monitoring, or upon other desired conditions.

When that subframe update is requested from the web browser 25 as a secondary operation, the web server 35 recognizes the subframe and may decide not to update the subframe if no change has occurred in the state that the web server 35 is monitoring. The web server 35 waits till just before the HTTP update command (request) expires, and then responds to the request with another update request to the subframe to request that the web server 35 refresh the status frame. As a result, a request for update is perpetually sent to the web server 35 from the subframe in the web browser 25. Additionally, whenever the state that is monitored by the web server 35 changes, the web server 35 sends an update to the status frame so that the status frame shows the current status of the state machine monitored/maintained by the web server 35. Therefore, the web server 35 provides virtually realtime status update to the web browser 25. Such a realtime response can be achieved with very low rate polling mechanism without the need to utilize additional features of HTTP, and in particular MIME types. For example, Internet Explorer does not support the Push MIME type, and the present invention does not require the Push MIME type.

As such, the standard browser client can be used to monitor and present status of a service device in virtually real-time manner, while requiring minimal traffic overhead to accomplish the monitoring function. This example concentrates on the monitoring task, because that is the intended focus. Many other operations are possible, and the description herein focuses on the real-time monitoring aspect of network command and control for consumer electronics devices in a home network. However, those skilled in the art will recognize that the present invention is useful with other types of networks and network protocols as well.

In one implementation described below, the web server 35 holds onto a poll for a change in state until either a change occurs, at which time it updates the web browser 25, or a timeout occurs. In one example, this allows for less than about 1 second response time but with an overhead that is between about 1 I/O per 12 seconds and about 1 I/O per 120 seconds. This timeout is within the tuning parameters of the TCP/IP roundtrip timeout (about 120 to 300 seconds) and within the user interfaces timeout for HTTP requests, which can be set to approximately the same range of magnitude.

An example program listing is provided below which runs as a Common Gateway Interface (CGI) program under Mod-Perl in an Apache web server. CGI provides a standardized application programming interface (API) that allows the Web Server to extend its function in a myriad of ways. In one example, the CGI is used for generating side effects in the client server interaction that can result in purchasing products from a website or controlling what video content is playing on the TV. The CGI's first application was to produce dynamic HTML displays on the Web Browser which are a result of user interaction. But it is the Web Servers standard interface to Sales and other Information DataBases and also to Device State Machines for control purposes.

The program listing below is in the Perl programming language, and resides in a fame update program (“frupd.pl”). A Mod-Perl is a Perl interpreter that is resident in the Apache web server for the purpose of running Perl programs to perform the CGI function. The CGI function is the “hook” for the Apache server, without which the Apache server would simply provide web pages to the web browser. For example, the CGI program can parse user data entered into the web browser, and store that data into a server side central database.

In addition, the CGI program is utilized according to an embodiment of the present invention in the client server process to allow a client device 20 including a web browser 25 (FIG. 2) to control a consumer electronics device such as a TV (i.e., service device 30 including web server 35). The Apache web server is the web server 35 and resides in the TV for monitoring the state of the TV. The client device 20 can comprise a network controller which makes presentations on the TV screen and receives user selected commands via the web browser 25 that also resides in the same TV in the living room (as such the client and server can be logical units in the same physical device). Or, the web server 35 can reside in another TV across the home network in the bedroom, or in a web pad connected via WiFi to the bedroom TV, etc. Other examples are possible. In this example, the main requirement on these browsers is that they are conformal to XHTML1.0, and JavaScript 1.3.

The CGI task provides a dynamic web page (i.e., status frame) that varies with the state of the TV. In this example task, the web server 35 provides a status indicator back to the web browser 25, indicating whether the TV is ON or OFF. The frame update (frupd) program only generates three possible outputs:
1. load the browser subframe (i.e., small requestor frame) with a Javascript program to request another running of this CGI program after e.g. 1 second.
2. load the first brother frame (indicated by parent.frames [0] . . . ) with the html file: tvon.html, plus 1.
3. load the first brother frame with the html file: tvoff.html, plus 1.

Output #1 occurs when there is no change of state in the TV for an entire 10 second period. That is, the file “changedone” is never deleted (unlinked) for the entire waiting period of approx 10 seconds.

Output #2 occurs when the CGI task detects that the file “changedone” does not exist and the current_index value is odd.

Output #3 occurs when the CGI task detects that the file changedone does not exist and the current_index value is even.

The “frupd.pl” program file is as follows:

```
#!c:/usr/bin/perl -w
# file: frupd.pl.
# This CGI task checks for changes in the local server state machine.
# If the file “changedone” does not exist then a change of state has occurred.
# For this particular implementation a change means that the TV goes from a power-on
state to a
# power-off state, and vice-versa in sequence.
# This CGI is requested from a very small frame.
# Initially, if no change is indicated then it loops checking for change each second for 10
seconds.
# If still no change then it causes the frame to reload its Javascript to run this CGI again
after 1 second.
#
use CGI;
$p = “/var/www/perl/”;
$query = new CGI;
print $query->header;
$changedone = “/home/jack/changedone”;
$c = 0;
open( IN, $p . “current_index.fil”);
$a = <IN>;
chomp($a);
close( IN );
while ( ( -e $changedone ) && ( $c < 10)){
    $c = $c + 1;
    system( “sleep 1s” );
    };
#If no change has occurred then changedone exists.
print “<html><head><title> Frame change checker Javascript.</title></head>\n”;
print “<body><script>\n” ;
if ( !( -e $changedone) ) {
  if ( ( $a % 2 ) == 1 ){
    $u = “http://105.144.43.120/tvon.html”;
  } else {
  $u = “http://105.144.43.120/tvoff.html”; };
open ( OUT, “>/home/jack/changedone” )∥die(“cannot open /home/jack/changedone”);
print OUT $a.“\n” ;
close ( OUT ) ∥ die ( “cannot close changedone”) ;
print “parent.frames[0].location.href=\“”. $u . “\”;\n” ;
};
print “setTimeout(‘location.href=\“http://105.144.43.120/perl/frupd.pl\”;’,1000);\n”;
print “</script></body></html>\n”;
```

Below is the program file “change.pl”, which is coded in perl. The “change.pl” program indicates that the device state machine has changed state. As the device in this example is a TV and the change of state is the power toggle, then the state status indicators are named “tvon” and “tvoff”. The absolute state of the TV is encoded in the variable $a which in this program is incremented and stored in the file called “current_index.fil”. Running this program is equivalent to pressing the TV's front panels or remote controls power toggle button. The actual change of state is signaled by deleting the file “changedone”. The CGI task uses the absence of that file to read that a change of TV state has occurred.

#!/usr/bin/perl -w
# filename: change.pl created Nov 19, 2003 by JW Chaney.
# opens “current_index.fil” in the /var/www/perl
directory and reads the first line.
# The first line of text is a number. That number is incremented.
# The “current_index.fil” is deleted. The file “temporary” is
created with the new
incremented number.
# The file “temporary” is renamed to “current_index.fil”.
open( IN, “current_index.fil”);
$a = <IN>;
chomp( $a );
$b = $a + 1;
close( IN );
unlink( “current_index.fil” );
open( OUT , “>temporary”);
print( OUT $b . “\n” ) ;
close( OUT );
rename( “temporary”, “current_index.fil” );
system( “chmod 0777 current_index.fil” );
if( -e “/home/jack/changedone” ){
unlink( “/home/jack/changedone” );};

The program file below, “twofr.html”, is the file that the browser 25 obtains using an HTTP GET command to begin monitoring the control of the TV device.

<?xml version=“1.0” encoding=“ISO-8859-1”?>
<!DOCTYPE html PUBLIC “-//W3C//DTD XHTML 1.0 Frameset//EN”
“http://www.w3.org/TR/xhtml1/DTD/xhtml1-frameset.dtd”>
<html xmlns=“http://www.w3.org/1999/xhtml”>
<head>
<title>Using vertical frames</title>
</head>
<frameset cols=“99%, 1%”>
<frame name=“left” src=“http://105.144.43.120/tvoff.html” />
<frame name=“right” src=“http://105.144.43.120/perl/frupd.pl” />
</frameset>
</html>

The program file below, “tvoff.html”, presents a 200 w×130 h graphic of a TV with a black screen, i.e., turned off.

<html>
<head>
<title> TV power off </title></head>
<body>
<img src=“tvpoweroff.GIF” align=“left”>
</body>
</html>

The program file below, “tvon.html”, presents a 200 w×130 h graphic of a TV with a service logo and a playing program title (i.e., the status of TV that someone may watching).

<html>
<head>
<title> TV power on </title></head>
<body>
<img src=“tvpoweron.GIF” align=“left”>
</body>
</html>

The example program segments/files above can be executed as a simulation on a Linux PC platform running the Apache Web Server and the Perl task change, where the Linux PC simulates the monitored TV and the change task represents the Power Toggle button. The Linux PC was connected to a Windows platform running Internet Explorer as the client that presents the monitored results. The results of executing this example is that during a no-change interval, there is an exchange of update requests from the client browser to the server at a rate of 1 request every 12 seconds. Also, there is less than 1 second response time to display the updated status when someone does press the power toggle button.

Further the example programs above are provided for the purpose of explanation of the frame update technology, and several simplification were used for ease of understanding. Such simplification are seen where values are stored in rotating disk files instead of using inter-process shared memory. In addition, a disk delete and rename operation is used instead of using proper semaphore controlled access to insure certain operations are atomic and the control is seamless. Further, those skilled in the art can extend the programs to support multiple controller clients by not using the reading, writing, deleting, and testing the existence of disk files used in the example programs. Instead, the use of atomic operations, semaphores, and shared global memory allows support of multiple client controllers easily. These latter methods are commonly applied to embedded systems in consumer electronics and their use does not need to be further discussed here.

As such, the standard browser client can be used to monitor and present status of a service device in virtually real-time manner, while requiring minimal traffic overhead to accomplish the monitoring function.

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures above according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

1. A method of pushing notifications to devices in a network, comprising the steps of:
(a) establishing a connection with one of the devices;
(b) receiving a request for data from the device; and
(c) sending a reply to the device in response to the request, wherein the reply includes a notification request for the device to request further information.

2. The method of claim 1 further including the steps of:
(d) automatically notifying the device if an event has occurred.

3. The method of claim 1 wherein step (c) further includes the steps of including data requested by the device in the reply.

4. The method of claim 1 further including the steps of:
(d) based on the notification request, receiving another request for data from the device; and
(e) sending another reply to the device in response to that request, wherein the reply includes another notification request for the device to request further information.

5. The method of claim 4 further including the steps of:
(f) automatically notifying the device if an event has occurred.

6. The method of claim 1 wherein the device includes a web browser that sends the request.

7. A method of pushing notifications to devices in a network, comprising the steps of:
(a) establishing a connection with one of the devices;
(b) sending a request for data to the device;
(c) receiving a reply from the device, wherein the reply includes a notification request for requesting further information from the device.

8. The method of claim 7 further including the steps of:
(d) automatically receiving a notification for an event from the device.

9. The method of claim 7 wherein step (c) further includes the steps of receiving the requested data in the reply.

10. The method of claim 7 further including the steps of:
(d) based on the notification request, sending another request for data to the device.

11. The method of claim 10 further including the steps of:
(e) receiving sending another reply from the device in response to the other request, wherein the reply includes another notification request for to request further information from the device.

12. The method of claim 11 further including the steps of:
(f) automatically receiving notifying from the device if an event has occurred.

13. The method of claim 7 wherein the device includes a web server that sends the reply.

14. A method of pushing notifications to devices in a network including client devices and server devices, comprising the steps of:
(a) establishing a connection between a client device and a server device;
(b) the client device sending a request for data to the server device;
(c) the server device sending a reply to the client device in response to the request, wherein the reply includes a notification request for the client device to request further information from the server device.

15. The method of claim 14 further including the steps of:
(d) the server device automatically notifying the client device that an event has occurred.

16. The method of claim 14 wherein step (c) further includes the steps of the server device including data requested by the client device in the reply.

17. The method of claim 16 further including the steps of:
(d) the client device displaying the requested data on a display.

18. The method of claim 14 wherein the client device includes a web browser that sends the request and the server device includes a web server that sends the reply.

19. The method of claim 14 further including the steps of:
(d) based on the notification request the client device sending another request for data from the server device; and
(e) the server device sending another reply to the device in response to that request, wherein the reply includes another notification request for the client device to request further information from the server device.

20. The method of claim 19 further including the steps of:
(f) the server device automatically notifying the client device if an event has occurred.

21. A system for pushing notifications to electronic devices, comprising:
a client device and a server device, such that a connection can be established between the client device and a server device;
the client device and the server device are configured such that:
the client device sends a request for data to the server device;
upon receiving the request, the server device sends a reply to the client device, wherein the reply includes a notification request for the client device to request further information from the server device.

22. The system of claim 21 wherein the server device automatically notifies the client device that an event has occurred.

23. The system of claim 21 wherein the server device further includes data requested by the client device in the reply.

24. The system of claim 23 wherein the client device displays the requested data on a display.

25. The system of claim 21 wherein the client device includes a web browser that sends the request and the server device includes a web server that sends the reply.

26. The system of claim 21 wherein:
(d) based on the notification request the client device sends another request for data from the server device; and
(e) the server device sends another reply to the device in response to that request, wherein the reply includes another notification request for the client device to request further information from the server device.

27. The system of claim 26 further including the steps of:
(f) the server device automatically notifying the client device if an event has occurred.

28. The system of claim 21 wherein the client device and the server device utilize the HTTP protocol.
